(19) United States
(12) Patent Application Publication
(10) Pub. No.: US 2014/0289238 A1
(43) Pub. Date: Sep. 25, 2014

(54) DOCUMENT CREATION SUPPORT APPARATUS, METHOD AND PROGRAM

(71) Applicant: KABUSHIKI KAISHA TOSHIBA, Tokyo (JP)

(72) Inventors: Kosei Fume, Kawasaki-shi (JP); Masaru Suzuki, Kawasaki-shi (JP); Masayuki Okamoto, Kawasaki-shi (JP); Kenta Cho, Kawasaki-shi (JP)

(73) Assignee: KABUSHIKI KAISHA TOSHIBA, Tokyo (JP)

(21) Appl. No.: 14/186,761

(22) Filed: Feb. 21, 2014

(30) Foreign Application Priority Data
Mar. 21, 2013 (JP) 2013-059113

(51) Int. Cl. G06F 17/30

(52) U.S. Cl. CPC G06F 17/30675
USPC 707/728

(57) ABSTRACT

According to one embodiment, a document creation support apparatus includes a determination unit, a search unit and a presentation unit. The determination unit determines a document type that is a type of a document containing a target character string, based on feature values including a first character recognition result and a first position information item. The search unit searches, if a search condition for searching for relevant character strings is satisfied, one or more databases for the relevant character strings to obtain the relevant character strings in order of decreasing score based on priorities, each of the priorities being set to each of the one or more databases according to the document type. The presentation unit presents the relevant character strings in order of decreasing the score.

### CROSS-REFERENCE TO RELATED APPLICATIONS

This application is based upon and claims the benefit of priority from Japanese Patent Application No. 2013-059113, filed Mar. 21, 2013, the entire contents of which are incorporated herein by reference.

### FIELD

Embodiments described herein relate generally to a document creation support apparatus, method and program.

### BACKGROUND

In recent years, hardware and software computing environments have been dramatically improved. In particular, the spread and improved performance of small terminals have contributed to the prevalence of tablet handwriting terminals, which are otherwise impractical due to the insufficiency of throughput and storage capacity of such terminals, and software that mimics the operability of paper and a pencil.

With an increase in the usage of handwriting terminals and software for handwriting, handwritten character recognition techniques have also prevailed which not only store handwriting information as images but also recognize handwriting information as electronic texts. Storing the results of recognition of handwriting information as electronic texts allows the results to be used for searches and reutilized. Furthermore, techniques have been common which connect to a network environment to lay created documents open to the public or to allow created documents to be shared.

In creation of a handwriting document, a user can provide inputs by free writing strokes using a pen or a stylus, unlike in the creation of an electronic text via a common keyboard. Thus, it is assumed that even when the user inputs a word mistakenly memorized by the user or a very ambiguous keyword or phrase, candidates based on a kana-kanji conversion function fail to be constrained, precluding the user from noticing the mistake. The following assumption can also be made. If the user inputs a character string in an abbreviated form, the user may fail to remember the content of the character string during reviewing such at a later date, or when the corresponding text is shared, other people may fail to understand the content.

Furthermore, the handwritten character recognition technique generally has an insufficient character recognition accuracy compared to a type OCR (Optical Character Reader) technique or the like. Hence, when an electronic text resulting from character recognition of handwriting information is searched, character misrecognition may preclude the document written by the user from being searched or prevent the electronic text from being correctly classified.

### BRIEF DESCRIPTION OF THE DRAWINGS

FIG. 1 is a block diagram illustrating a document creation support apparatus;

FIG. 2 is a flowchart illustrating operation of the document creation support apparatus;

FIG. 3A is a diagram illustrating a first example of a search condition determined by a feature extraction unit;

FIG. 3B is a diagram illustrating a second example of a search condition;

FIG. 3C is a diagram illustrating a third example of a search condition;

FIG. 3D is a diagram illustrating a fourth example of a search condition;

FIG. 3E is a diagram illustrating a fifth example of a search condition;

FIG. 4 is a flowchart illustrating a document type generation process;

FIG. 5 is a flowchart illustrating a type determination process in a type determination unit;

FIG. 6 is a flowchart illustrating a correspondence table generation process;

FIG. 7 is a flowchart illustrating a search process in a candidate search unit;

FIG. 8A is a diagram illustrating a first specific example of a score calculation process in the candidate search unit;

FIG. 8B is a diagram illustrating a second specific example of a score calculation process;

FIG. 9A is a diagram illustrating a first example of a user interface displayed in a presentation unit;

FIG. 9B is a diagram illustrating a second example of a user interface;

FIG. 10 is a diagram illustrating a user interface according to a character recognition accuracy; and

FIG. 11A is a diagram illustrating a first example of a character string resizing process.

FIG. 11B is a diagram illustrating a second example of a character string resizing process.

### DETAILED DESCRIPTION

A technique is available which corrects character misrecognition by a majority vote on the Internet and which is expected to successfully correct the misrecognition of common keywords. However, in view of applications of personal handwritten notes, the number of hits on the Internet is not always effective in correcting the misrecognition. That is, for words or abbreviated words assumed for personal notes, words with a large number of hits on the Internet may not be appropriate candidates. Moreover, for interpolation or correction of jargon or technical terms used within a team or an in-house department, which is likely to share documents among the members thereof, appropriate candidates fail to be presented. Furthermore, the technique for correction based on a majority vote fails to present appropriate candidates for co-occurring compound words or phrases or a set of words or phrases appearing away from each other within the text.

In general, according to one embodiment, a document creation support apparatus includes a determination unit, a search unit and a presentation unit. The determination unit is configured to determine a document type that is a type of a document containing a target character string, based on feature values including a first character recognition result and a first position information item, the target character string being a character string to be processed, the first character recognition result being a result of character recognition of the target character string, the first position information item indicating a position that the target character string appears in the document. The search unit is configured to search, if a search condition for searching for relevant character strings is satisfied, one or more databases for the relevant character strings to obtain the relevant character strings in order of decreasing score based on priorities, the relevant character strings being associated with the target character string, each of the priorities being set to each of the one or more databases according to the document type. The presentation unit is configured to present the relevant character strings in order of decreasing the score.

A document creation support apparatus, method and program according to the present embodiment will be described below with reference to the drawings. In the embodiment described below, components denoted by the same reference numerals are assumed to perform similar operations, and duplicate descriptions are omitted where appropriate.

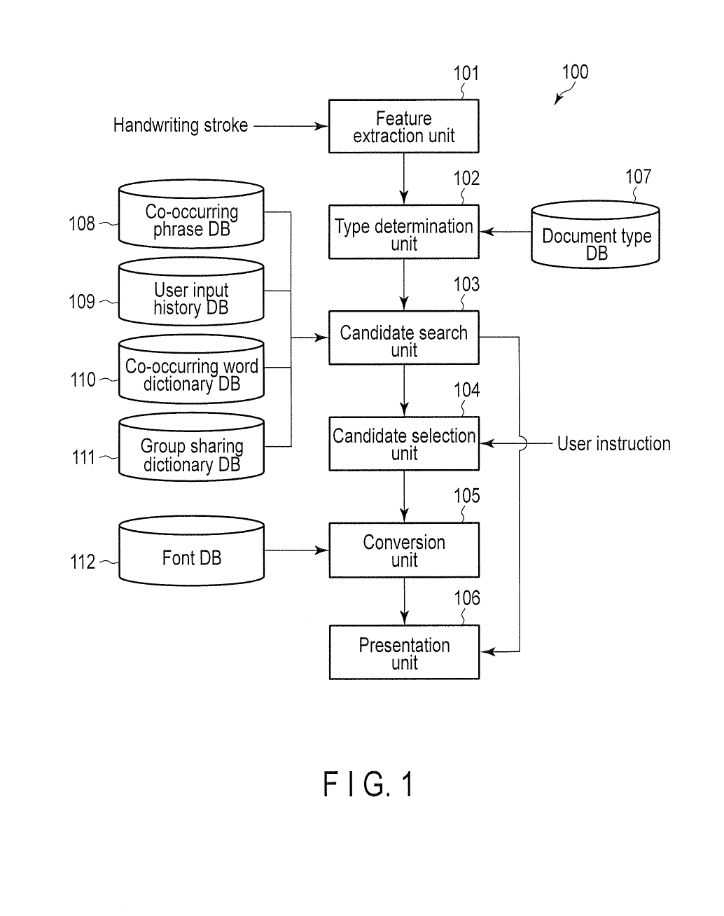

A document creation support apparatus according to the present embodiment will be described with reference to a block diagram in FIG. 1.

A document creation support apparatus 100 includes a feature extraction unit 101, a type determination unit 102, a candidate search unit 103, a candidate selection unit 104, a conversion unit 105, a presentation unit 106, a document type database 107 (hereinafter referred to as a document type DB 107), a co-occurring phrase database 108 (hereinafter referred to as a co-occurring phrase DB 108), a user input history database 109 (hereinafter referred to as a user input history DE 109), a co-occurring word dictionary database 110 (hereinafter referred to as a co-occurring word dictionary DB 110), a group sharing dictionary database 111 (hereinafter referred to as a group sharing dictionary DB 111), and a font database 112 (hereinafter referred to as a font DE 112).

The feature extraction unit 101 externally receives a document and extracts, as feature values for the document, character recognition results obtained by a character recognition process carried out on a target character string to be processed which is contained in the document, and position information indicating that the target character string appears in the document. The position information may include, for example, information on the position of the target character string in the document and the positions of a line and a paragraph block containing the target character string.

Furthermore, when a text received by the feature extraction unit 101 is handwriting strokes provided by a user, the feature extraction unit 101 carries out a handwritten character recognition process on the handwriting strokes. The feature extraction unit 101 then extracts position information and the results of character recognition carried out on a target character string that is a set of handwriting strokes, as feature values of the text containing the target character string. The character recognition process may be a common character recognition process and will thus not be described.

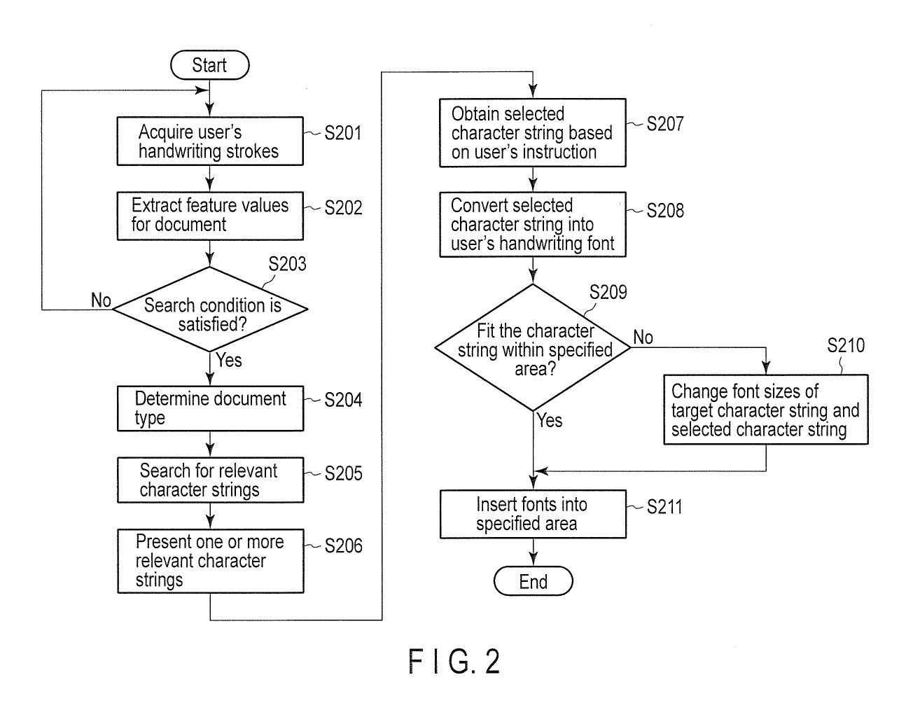

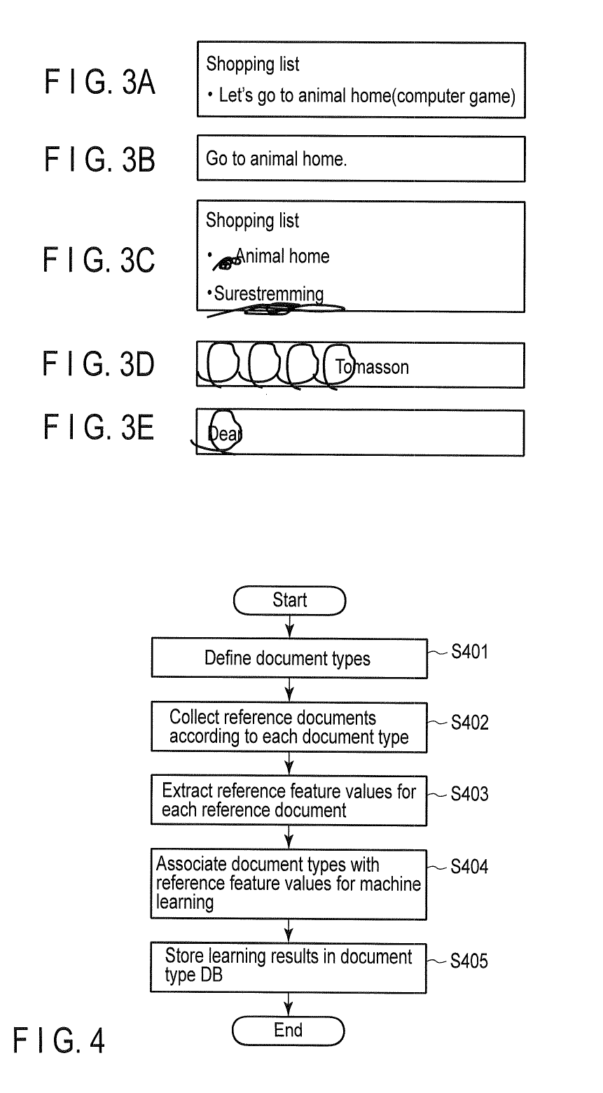

Furthermore, the feature extraction unit 101 determines whether or not the target character string satisfies a search condition that is needed to search for relevant character strings. The relevant character strings indicate correction candidate character strings or interpolation candidate character strings for the target character string. Upon determining that the target character string satisfies the search condition, the feature extraction unit 101 passes the feature values to the type determination unit 102. The search condition will be described below with reference to FIG. 2 and FIGS. 3A to 3E.

The type determination unit 102 receives the feature values from the feature extraction unit 101, and references the document type DB 107 to determine a document type that is the type of the document containing the target character string, based on the feature values. Examples of the document type include general documents such as a diary, a letter, and a paper and personal documents such as Minutes notes, an in-house note, and a shopping list.

The candidate search unit 103 receives the feature values and the document type from the document determination unit 102. The candidate search unit 103 searches the co-occurring phrase DB 108, the user input history DB 109, the co-occurring word dictionary DB 110, and the group sharing dictionary DB 111, which are search sources, for character strings associated with the target character string based on priorities of databases set according to the document type. The candidate search unit 103 thus obtains one or more relevant character strings in order of decreasing score based on the priorities.

The candidate selection unit 104 receives the one or more relevant character strings from the candidate search unit 103. The candidate selection unit 104 selects from the relevant character strings in accordance with the user's instruction to obtain a selected character string.

The conversion unit 105 receives the selected character string from the candidate selection unit 104 and converts the font of the selected character string into a font to be stored in the font DB 112. If an area is specified in which the selected character string and the target character string are displayed and the current font size prevents the selected character string and the target character string from fitting within the area when the character strings are displayed, the conversion unit 105 adjusts the font sizes of the selected character string and the target character string so as to fit the selected character string and the target character string within the area.

The presentation unit 106 receives the target character string and the relevant character strings from the candidate search unit 103 and presents the target character string and the relevant character strings on a display or the like. At this time, the relevant character strings are presented in order of decreasing score based on the priorities. Furthermore, when a selected character string is obtained in accordance with the user's instruction, the presentation unit 106 receives, from the conversion unit 105, the selected character string with the font thereof converted or the selected character string and target character string with the fonts thereof converted and the font sizes thereof adjusted, and presents the target character string and the selected character string.

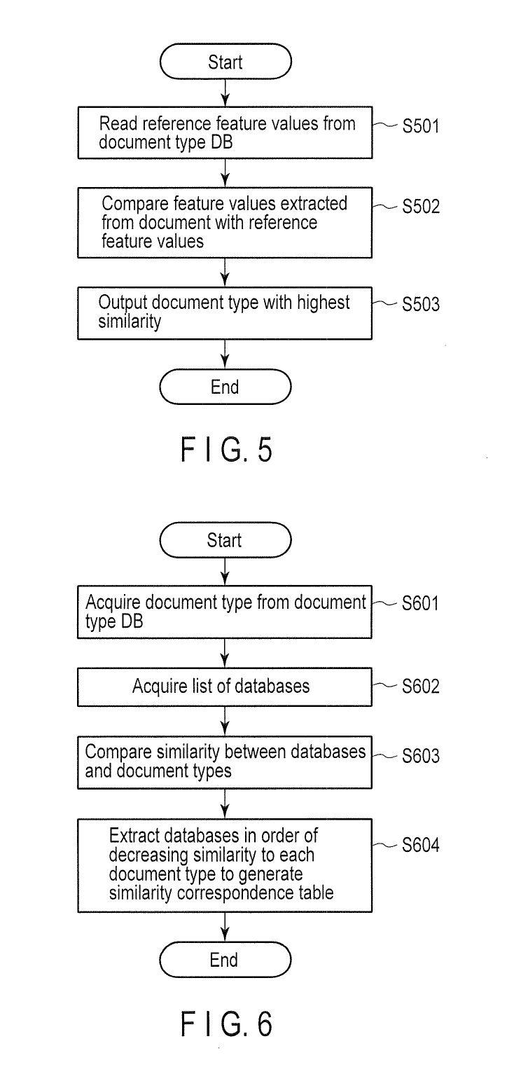

The document type DB 107 stores an identifier (ID) for the document type and a reference feature value in association with each document type. The reference feature value serves as a reference for determining the document type. The reference feature value will be described below with reference to FIG. 5.

The co-occurring phrase DB 108 stores common new words and unknown co-occurring words in association with one another using a corpus based on web documents or the like.

The user input history DB 109 stores combinations of co-occurring words from the history of keywords and phrases input by the user.

The co-occurring word dictionary DB 110 stores common co-occurring words, proverbs, correspondences between season words, dependencies, grammatical constraints, and the like.

The group sharing dictionary DB 111 stores characteristic words, symbols, and the like used within a specific group or among specific members and commonly used within a group to which the user belongs.

The font DB 112 stores a font based on the user's handwriting strokes and general type fonts as font information.

Now, operation of the document creation support apparatus 100 will be described with reference to a flowchart in FIG. 2.

In an example illustrated in FIG. 2, handwriting strokes are received from the user and processed. However, documents formed of type character strings input via a keyboard or the like may be similarly processed.

In step S201, the feature extraction unit 101 acquires handwriting strokes input by the user. The feature extraction unit 101 carries out a handwritten character recognition process on the handwriting strokes, and if the result of extraction is a text character string, acquires the text character string.

In step S202, the feature extraction unit 101 extracts position information and the results of character recognition carried out on the handwriting strokes to obtain feature values for the document containing the target character string.

In step S203, the feature extraction unit 101 determines whether or not the search condition is satisfied. According to the present embodiment, the search condition may be assumed to be satisfied upon satisfaction of any one of the condition that a particular action is input by the user, the condition that a particular character string is input, and the condition that a given period has elapsed without the user's input since the acquisition of the handwriting strokes, and satisfying any one of these conditions may indicate that the search condition is satisfied. If the search condition is satisfied, the process proceeds to step S204. If the search condition is not satisfied, the process returns to step S201 to continue acquiring handwriting strokes.

In step S204, the type determination unit 102 carries out a type determination process on the document containing the target character string to determine the document type. The type determination process will be described below with reference to FIG. 4 and FIG. 5.

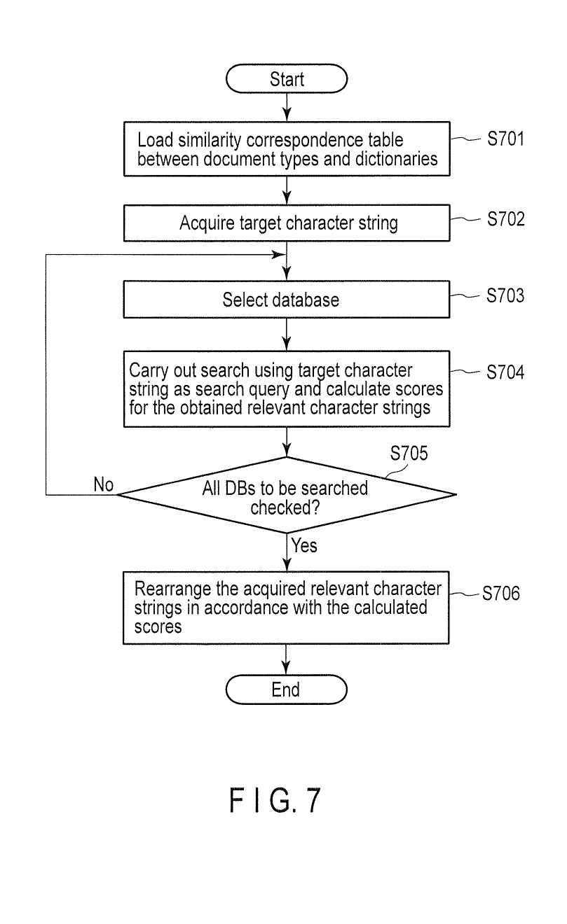

In step S205, based on the result of determination of the document type, the candidate search unit 103 searches the databases with the priorities set therefor according to the document type of the document containing the target character string, for character strings associated with the target character string. The candidate search unit 103 thus obtains relevant character strings in order of decreasing score based on the priorities. The search process by the candidate search unit 103 will be described below with reference to FIG. 6 and FIG. 7.

In step S206, the presentation unit 106 presents the target character string and one or more relevant character strings. In step S207, the candidate selection unit 104 selects a character string from the one or more relevant character strings based on the user's instruction to obtain a selected character string.

In step S208, the conversion unit 105 references the font DB 112 to convert the selected character string into the user's handwriting font. This allows the target character string expressed by the handwriting strokes to be matched, in the document, to the selected character string for insertion.

In step S209, the conversion unit 105 determines whether or not, when the selected character string with the font thereof converted is inserted into a specified area that is an insertion target, the character string fails to fit within the specified area. If the character string fails to fit within the specified area, the process proceeds to step S210. If, on the other hand, the character string fits within the specified area, the process proceeds to step S211.

In step S210, the conversion unit 105 adjusts the font sizes of the target character string and the selected character string so as to fit the target character string and the selected character string within the specified area.

In step S211, the conversion unit 105 inserts the target character string and the selected character string into the specified area of the document. Then, the operation of the document creation support apparatus according to the present embodiment ends.

The determination of the document type in step S204 may be omitted if the user predetermines the document type of the document to be created with reference to, for example, the type of an application with which the document is to be created. In this case, after the document type is determined, the processing in step S204 may be omitted and the processing in step S205 may be carried out after the processing in step S203. Furthermore, in step S208, the selected character string is converted into the handwriting font. However, the embodiment is not limited to this. The selected character string may be converted into a general type font. This allows an interpolated position of the target character string to be easily determined.

Next, an example of the search condition determined by the feature extraction unit 101 will be determined with reference to FIGS. 3A to 3B.

FIG. 3A shows an example in which the search condition is satisfied when a given time has elapsed without the user's input. The elapse of the given time corresponds to, for example, a time preset by the system or a time such as 3 seconds or 10 seconds which is set by the user, during which the user does not input any stroke or perform any other operation. The time may have a fixed value or may be a pause length appropriate for presenting candidates and dynamically determined by acquiring a speed at which the user inputs character strings and the tendency of the user to pause indicative of the time from the input of a certain character string until the input of the subsequent character string.

FIG. 3B illustrates an example in which the search condition is satisfied when a particular character string is input. The input of a particular character string corresponds to the input of a punctuation mark that is a break in a sentence or between sentences or a symbol such as an ending parenthesis. Alternatively, the search condition may be assumed to be satisfied when a particular pattern such as a proper noun or an inflectable word appears in results obtained by performing a morphological analysis to text recognition results.

As shown in FIG. 3A and FIG. 3B, given that the elapse of the given time or the input of the particular character string is the search condition, relevant character strings may be displayed when the user fails to notice an error.

FIG. 3C illustrates an example in which the search condition is satisfied when the user's action corresponding to a specification of an ambiguous portion is acquired. For example, the search condition may be assumed to be satisfied when, for example, the following action is input: a scratch is made or a plurality of consecutive taps are given at a position assumed for a character string serving as an interpolation candidate located before or after the target character string, or a wide range is underlined in a reciprocating manner. Such an action as shown in FIG. 3C is taken when the user understands that the target character string involves a certain co-occurring word but fails to remember or vaguely remembers the word. Hence, the system may be configured such that when such an action is input, the relevant character strings are presented.

FIG. 3D and FIG. 3E illustrate a case where the search condition is the input of the user's action corresponding to an example of a partial specification. For example, an input example may be assumed in which, for specification of an output, circles are drawn to represent spaces the number of which corresponds to the character string or a target character string that expands into a relevant keyword is marked by being circled. The user's action or marking is not limited to the above-described action or marking. The user's action or marking may be in any form including a user defined form provided that the user's action or marking can be interpreted as a stroke or an action and as a trigger for a search process by the system.

Now, a process of generating a document type pre-stored in the document type DB 107 will be described with reference to a flowchart in FIG. 4. The process illustrated in FIG. 4 is a preliminary process for presetting document types before a target character string is input.

In step S401, document types stored in the document type DB 107 are defined. For example, categories such as a note, a diary, a shopping list, and a paper may be the document types. The user may define the document types or prepare a plurality of types of document type groups.

In step S402, reference documents that are example sentences corresponding to each document type are collected. For example, the user's actual notes, diaries, or papers may be prepared according to the document type, note, diary, or paper, respectively. Reference documents may be appropriate documents collected by searching the web using the name of the document type, instead of being the user's data.

In step S403, the feature extraction unit 101 extracts reference feature values that are feature values for the reference documents. The reference feature values may be extracted by a process similar to the feature value extraction process carried out by the feature extraction unit 101 as described above. The reference feature values may include, for example, whether or not a word, a compound word, a parts-of-speech character string, a quantitative expression, and the like occur in the reference documents, and the position of the occurrence, as feature value vectors.

In step S404, the type determination unit 102 stores the reference feature values for the reference documents in association with the document types. Furthermore, the reference feature values and the document types may be learned as training data for machine learning. The type determination unit 102 carries out a morphological analysis on text extraction results obtained by applying a handwritten character recognition process on the handwritten characters, to obtain word class information and dependency parsing results. Even when the input of a text character string via a keyboard or the like is carried out instead of the input of stroke information via a pen, processing can be performed as is the case with a text character string resulting from handwritten character recognition. For the learning, means for discriminating the feature values from one another may be a general discriminator such as an SVM (Support Vector Machine), a CRF (Conditional Random Fields), or an ANN (Artificial Neural Network) which is used for a natural language process.

In step S405, the feature extraction unit 101 places a model corresponding to the results of learning of the association between the document types and the reference feature values, in the document type DB 107. Then, the document type generation process is completed.

Now, a type determination process in the type determination unit 102 will be described with reference to a flowchart in FIG. 5.

In step S01, the reference feature values are read from the document type DB 107.

In step S502, feature values extracted from the document containing the target character string are compared with the respective reference feature values for each document type stored in the document type DB 107 to calculate similarity.

Step S503 determines a type corresponding to reference feature values with the highest similarity to the feature values for the document containing the target character string to be the document type of the document containing the target character string. Then, the type determination process ends.

Now, a correspondence table generation process in which the type determination unit 102 pre-generates a correspondence table will be described with reference to a flowchart in FIG. 6. The process illustrated in FIG. 6 is a preliminary process for presetting the priorities of databases according to the document types before a target character string is input.

In step S601, document types and reference feature values are acquired from the document type DB 107.

In step S602, a list of referenceable databases is acquired. The referenceable databases can be accessed (read) by the system. The present embodiment is assumed to include the co-occurring phrase DB 108, the user input history DB 109, the co-occurring word dictionary DB 110, and the group sharing dictionary DB 111. The list can be acquired by searching for the available databases during setting or the system may be provided with a list clearly indicating locations where the databases are stored and the characteristics of the databases.

In step S603, based on the list, the similarity is compared between the databases and the document types. By way of example, document vectors can be generated by assuming a set of high frequency words with reference feature values corresponding to each document type to be a “document” characteristic of the document type. Thus, the similarity can be compared by calculating, for example, cosine similarities between document vectors for the document types and document vectors for words stored in the respective databases.

In step S604, based on the similarity between the document types and the databases, a similarity correspondence table is generated and held for which the databases have been extracted in order of decreasing similarity. That is, the set priority increases consistently with the similarity. The similarity correspondence table may allow a database to be searched to be determined, for example, as illustrated in Table 1.

TABLE 1

Definition 1: document type, [private memo] or [Shopping list]
Priority No. 1: Co-occurring phrase DB
Priority No. 2: User input history DB
Priority No. 3: Co-occurring word dictionary DB
Definition 2: document type, [general document] or [Minutes note]
Priority No. 1: Co-occurring phrase DB
Priority No. 2: Co-occurring word dictionary DB
Priority No. 3: Co-occurring word dictionary DB

The document types may be manually associated with the corresponding databases so that a particular database is used for a certain document type. Furthermore, the correspondence table resulting from the correspondence table generation process illustrated in FIG. 6 allows a database as a search source to be determined by determining the document type, and is thus not needed for every search process. Hence, a pre-output correspondence table may be referenced, and any correspondence table may be used provided that the correspondence table can be loaded into the system by, for example, distribution from a server.

Thus, when the priorities are set for the databases as search sources according to the document type, appropriate relevant character strings can be searched for according to the document. For example, a shopping list is likely to include products previously purchased by the user, and thus, for the shopping list, the user input history DB 109 may be set to have a high priority. A Minutes note is likely to include technical terms within a group, and thus, for such Minutes note, the group sharing dictionary DB 111 may be set to have a high priority.

Now, a search process in the candidate search unit 103 will be described with reference to a flowchart in FIG. 7.

In step S701, the candidate search unit 103 loads the similarity correspondence table between the document types and the databases.

In step S702, the candidate search unit 103 acquires, from the type determination unit 102, a target character string serving as a search query.

In step S703, the candidate search unit 103 selects a database with the highest priority based on the similarity correspondence table.

In step S704, the candidate search unit 103 searches the selected database by the target character string as a search query to acquire relevant character strings if any, that is, a character string that may be used as a correction candidate for the target character string and a character string serving as a co-occurring word for the keyword or another writing variation thereof. Moreover, the candidate search unit 103 calculates scores for the acquired relevant character strings taking the priorities into account.

In step S705, the candidate search unit 103 determines whether or not all the databases to be searched have been checked. If all the databases to be searched have been checked, the process proceeds to step S706. If the databases have not all been checked, in other words, any database has failed to be checked, the process returns to step S703 to repeat similar processing.

In step S706, the candidate search unit 103 rearranges the relevant character strings in accordance with the calculated scores. Then, the search process in the candidate search unit 103 ends.

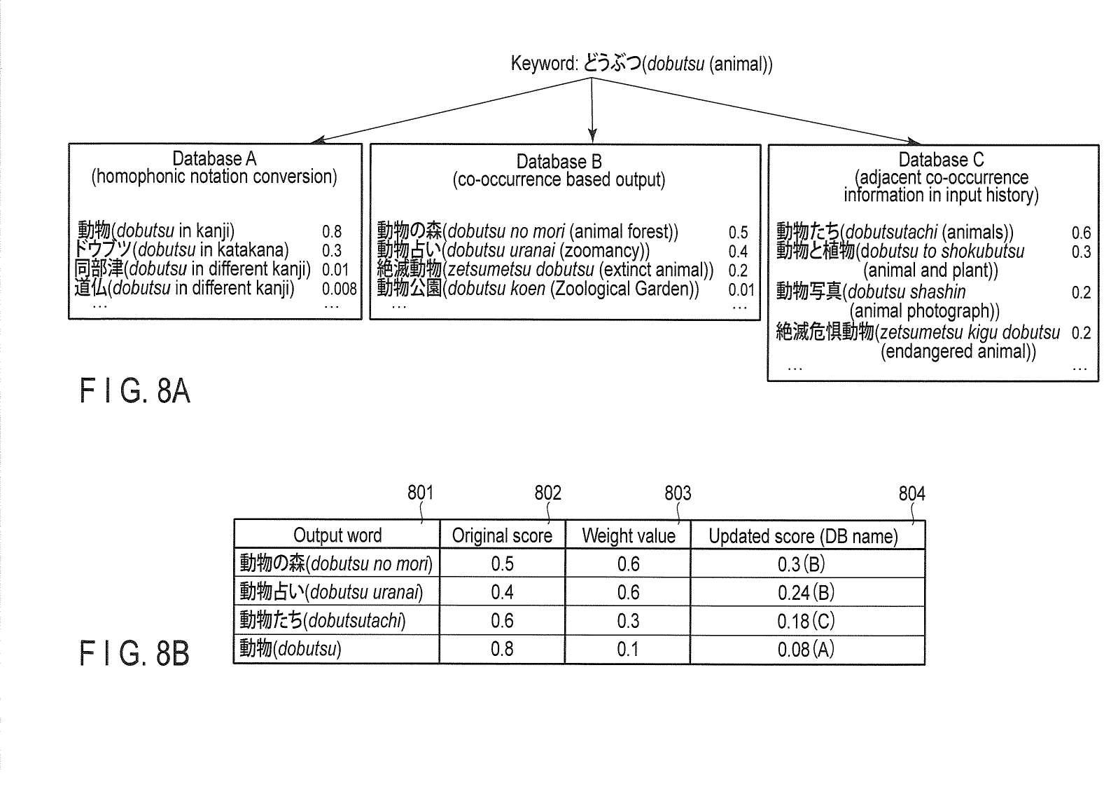

Now, a specific example of a score calculation process in the candidate search unit 103 will be described with reference to FIGS. 8A and 8B.

The example illustrated in FIGS. 8A and 8B assumes “ [symbol] [symbol] (dobutsu (animal))” is assumed to be a target character string in the document. Furthermore, in this example, three databases searched for the target character string are provided: a database A for homophonic writing conversion, co-occurrence database B describing co-occurrence frequencies based on statistical amounts from general documents, and user input history database C in which co-occurrence information on adjacent words calculated from the history of the user's inputs or inputs within a group is accumulated.

When the priorities are not taken into account, the scores for the relevant character strings for the target character string “ [symbol] (dobutsu)” are sorted in order of decreasing score in each database. Normalized co-occurrence frequencies are pre-calculated to be the scores in each database. In an example shown in FIG. 8A, relevant character strings acquired from the three databases in order of decreasing score are “ [symbol] (dobutsu): 0.8” in the database A, “ [symbol] (dobutsutachi (animals)): 0.6” in the database C, “ [symbol] (dobutsu no mori (animal forest)): 0.5” in the database B, and “ [symbol] (dobutsu uranai (zoomancy)): 0.4” in the database B.

Then, with reference to the similarity correspondence table, each score is multiplied by a weight value for each database based on the document type. In this case, the weight value is set to “0.1” for the database A, “0.6” for the database B, and “0.3” for the database C. A table in FIG. 8B shows the results of multiplication of the scores for the relevant character strings by the weight values for the databases.

In the table shown in FIG. 8B, relevant character strings 801, original scores 802, weight values 803, and updated scores 804 are associated with one another.

The relevant character string 801 is a character string associated with a target character string extracted from a dictionary.

The original score 802 is a score for similarity in the database to which the relevant character string belongs.

The weight value 803 is determined according to the corresponding a priority of database.

The updated score 804 is based on the original score 802 and the weight value 803 and shown with the name of the database in which the relevant character string is stored.

When the priorities of databases are taken into account, the scores are calculated as follows. For example, the relevant character string “ [symbol] (dobutsu) 0.8” has a weight value 803 of “0.1”, and thus, the updated score 804 is 0.8×0.1=0.08. Similarly, the relevant character string “ [symbol] (dobutsu no mori) 0.5” stored in the database B has a weight value 803 of “0.6”, the updated score 804 is 0.5×0.6=0.30.

The character string “ [symbol] (dobutsu)”, stored in the database A, has a higher original score than the relevant character string “ [symbol] (dobutsu no mori)”, stored in the database B. However, since the database B has a higher priority than the database A, “ [symbol] (dobutsu no mori)”, stored in the database B, has a higher score than the other relevant character strings. Thus, taking the priorities of databases into account allows the user to be presented with the appropriate character string corresponding to the document type.

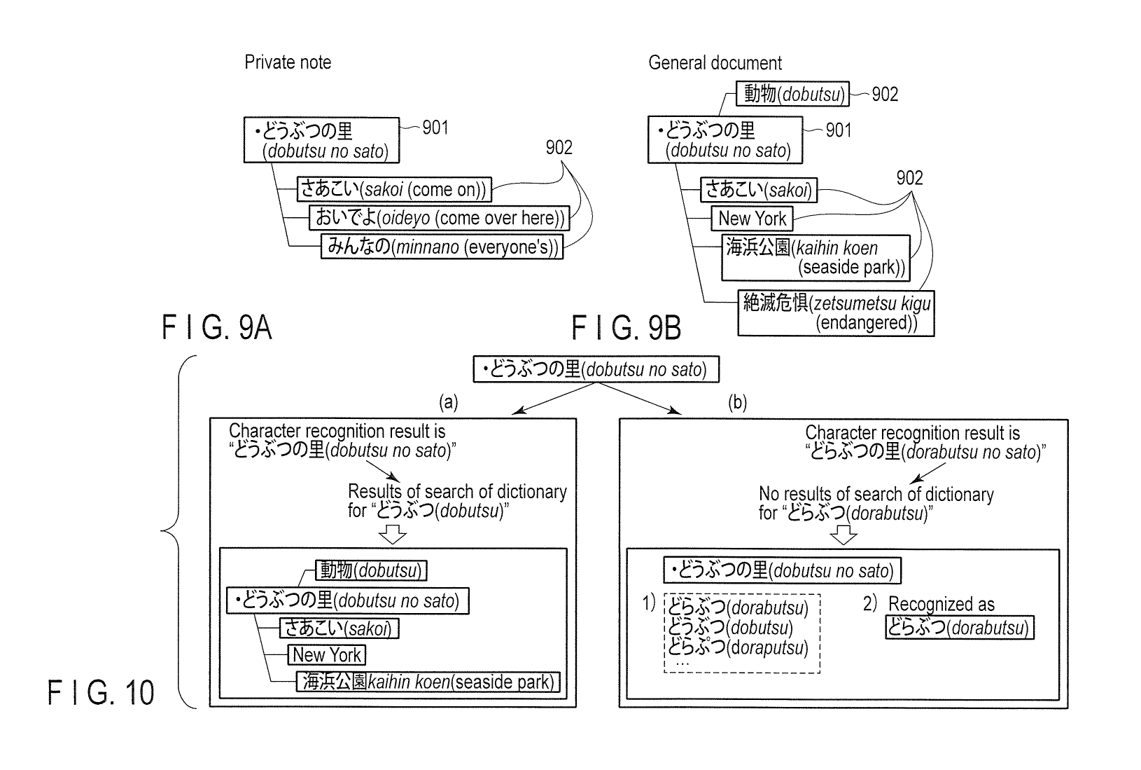

Now, an example of a user interface displayed in the presentation unit will be described with reference to FIGS. 9A and 9B.

FIG. 9A shows a case where the document type of a document containing a target character string is a shopping list. FIG. 9B shows a case where the document type of a document containing a target character string is a general document.

In the example shown in FIG. 9A, when the document type is a shopping list, the priorities for the databases are in the following order: the co-occurring phrase DB, the user input history DB, and the co-occurring word dictionary DB, as shown in Table 1. Thus, as co-occurring words for a target character string 901 “ [symbol] (dobutsu no sato (animal home))”, “ [symbol] [symbol] (saakoi (come on))”, “ [symbol] (oideyo (come over here))”, and “ [symbol] (minnano (everyone's))” are presented based on the scores.

Furthermore, the example illustrated in FIG. 9B involves the same keyword as that in FIG. 9A but a document type different from the document type in FIG. 9A; the document type in FIG. 9B is a general document. Thus, “ [symbol] (saakoi)”, “New York”, “ [symbol] (kaihin koen (seaside park))”, “ [symbol] (zetsumetsu kigu (endangered))”, and the like are presented as candidates, and as a conversion candidate for “ [symbol] (dobutsu)” in the target character string, “ [symbol] (dobutsu in Kanji)” is presented as a relevant character string 902.

The user can determine a selected character string by tapping or checking the user's intended relevant character string with a pen to confirm and select the relevant character string.

Now, an example of an output from the user interface corresponding to a character recognition accuracy will be described with reference to FIG. 10.

(a) of FIG. 10 shows the results of the correct character recognition of “ [symbol] (dobutsu)” in handwriting strokes. The results include candidates similar to the candidates shown in FIG. 9B, which involves the document type “general document”.

On the other hand, in an example shown in (b) of FIG. 10, the character string “ [symbol] (dobutsu)” is recognized as “ [symbol] [symbol] (dorabutsu)”, and the result of the character recognition is incorrect.

As “ [symbol] (dorabutsu)” is not listed in the dictionary it is thus determined to be a misrecognition. However, the misrecognition is not clearly indicated to the user. In this case, “ [symbol] (dorabutsu)” may be expanded into “ [symbol] (dobutsu)”, which is a character string close to “ [symbol] (dorabutsu)”, or “ [symbol] (doraputsu)”, which is another recognition candidate, and information may be held which indicates these character strings as relevant character strings. For searches, matching may be performed on character strings including these candidate words.

Furthermore, if the search condition is satisfied when, for example, the user underlines a display area for the target character string “ [symbol] (dobutsu no sato)”, the recognition result “ [symbol] (dorabutsu)” may be presented to urge the user to correct the result and to confirm the resultant character string.

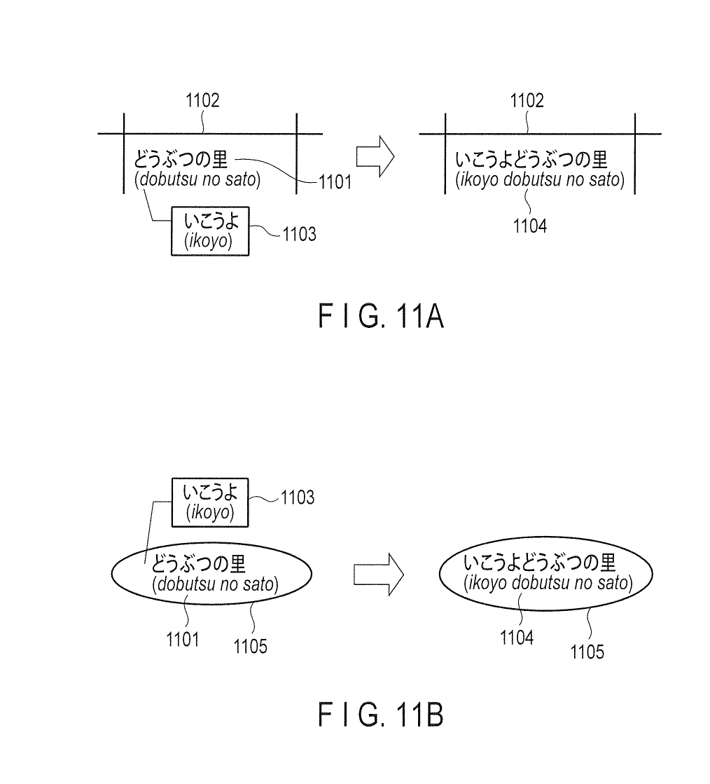

Now, a process of resizing a character string which process is carried out by the conversion unit 105 will be described with reference to FIGS. 11A and 11B.

The specified area (text area) into which the selected character string is to be inserted may have constraints regarding the length and height of the area, surrounding figures and ruled lines, and the logical structure of the area. FIG. 11A shows an example in which a character string described within a table (a cell) is interpolated before being inserted back into the cell. A target character string 1101 “ [symbol] [symbol] ” written using the user's handwriting strokes includes characters written with the font size of a cell 1102 taken into account. However, insertion of a relevant character string 1103 “ikoyo (let's go))” without any change prevents the resultant character string from fitting within the area. Hence, when the user confirms the relevant character string “ [symbol] [symbol] (ikoyo” and finishes writing “ [symbol] (dobutsu on sato)”, the font size of one phrase 1104 “ [symbol] [symbol] (ikoyo dobutsu no sato (let's go to the animal home))” is collectively changed and reduced so as to fit entirely within a cell 1102 in the document.

FIG. 11B shows an example in which a character string is written into a figure 1105. Also in FIG. 11B, a relevant character string 1103 avoids being immediately inserted into the figure 1105 upon being confirmed. When a phrase 1104 within the figure is finished, the character size of the entire phrase 1104 is reduced.

The embodiment is not limited to the resizing of a character string. Instead of the size of a character string, the size of a cell or figure may be changed. Furthermore, when the font size is changed, the color of the characters may be changed to allow the changed portion to be easily determined.

Thus, with the user's characteristics strokes such as handwriting habits and original symbols taken into account, the system can forcibly correct character misrecognitions or the user can proceed with writing naturally. Furthermore, a word occurring along with but away from a target character string can be presented as a relevant character string. For example, when the document type is a letter, the user can be presented with, as relevant character strings, a set of greeting words occurring away from each other within a document, such as “ [symbol] (haikei (Dear . . . ))”, which appears at the beginning of a letter, and “ [symbol] (keigu (Truly Yours))”, which appears at the end of the letter. Moreover, the embodiment can be utilized for word searches associated with handwriting strokes.

According to the embodiment described above, for a character string assumed to involve a user's handwriting error or ambiguity, the document creation support apparatus can present appropriate candidates based on the contents of the document by changing the database according to the type of the document. Furthermore, in inserting a selected character string into the document, the user can insert the desired character string into the document simply by a selection operation of changing the font of the character string to the user's handwriting or changing the font size of the character string so that the character string fits within a specified area. The document creation support apparatus according to the present embodiment can thus efficiently support the user in creating documents.

The flowcharts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document creation support apparatus comprising:
a determination unit configured to determine a document type that is a type of a document containing a target character string, based on feature values including a first character recognition result and a first position information item, the target character string being a character string to be processed, the first character recognition result being a result of character recognition of the target character string, the first position information item indicating a position that the target character string appears in the document;
a search unit configured to search, if a search condition for searching for relevant character strings is satisfied, one or more databases for the relevant character strings to obtain the relevant character strings in order of decreasing score based on priorities, the relevant character strings being associated with the target character string, each of the priorities being set to each of the one or more databases according to the document type; and
a presentation unit configured to present the relevant character strings in order of decreasing the score.

2. The apparatus according to claim 1, further comprising an extraction unit configured to extract, if the target character string is a handwriting stroke, a second character recognition result of the character recognition of the handwriting stroke and a second position information item on a character string represented by the handwriting stroke, as the feature values.

3. The apparatus according to claim 1, further comprising a conversion unit configured to change sizes of fonts of the target character string and a selected character string so that the target character string and the selected character string fit within a specified area in the document if the selected character string is inserted in the specified area, the selected character string being one of the relevant character strings selected in accordance with a user's instruction.

4. The apparatus according to claim 3, wherein the conversion unit converts the selected character string into the user's handwriting font and inserts the converted selected character string into the document.

5. The apparatus according to claim 1, wherein the search unit determines the search condition to be satisfied upon satisfaction of one of a first condition that an appearance pattern of a character string or a part of speech which are preset as the first character recognition result is recognized, a second condition that an action performed on the target character string is input by the user's handwriting stroke, and a third condition that a first period has elapsed without the user's input since the acquisition of the handwriting stroke.

6. The apparatus according to claim 1, wherein the one or more databases include a database generated based on a character string appearing in a document shared among a plurality of users.

7. The apparatus according to claim 1, wherein the presentation unit presents another relevant character string according to the first character recognition result.

8. A document creation support method comprising:
determining a document type that is a type of a document containing a target character string, based on feature values including a first character recognition result and a first position information item, the target character string being a character string to be processed, the first character recognition result being a result of character recognition of the target character string, the first position information item indicating a position that the target character string appears in the document;
searching, if a search condition for searching for relevant character strings is satisfied, one or more databases for the relevant character strings to obtain the relevant character strings in order of decreasing score based on priorities, the relevant character strings being associated with the target character string, each of the priorities being set to each of the one or more databases according to the document type; and
presenting the relevant character strings in order of decreasing the score based on the priorities.

9. The method according to claim 8, further comprising extracting, if the target character string is a handwriting stroke, a second character recognition result of the character recognition of the handwriting stroke and second position information on a character string represented by the handwriting stroke, as the feature values.

10. The method according to claim 8, further comprising changing sizes of fonts of the target character string and a selected character string so that the target character string and the selected character string fit within a specified area in the document if the selected character string is inserted in the specified area, the selected character string being one of the relevant character strings selected in accordance with a user's instruction.

11. The method according to claim 10, wherein the changing the sizes of fonts converts the selected character string into the user's handwriting font and inserts the converted selected character string into the document.

12. The method according to claim 8, wherein the searching for the relevant character strings determines the search condition to be satisfied upon satisfaction of one of a first condition that an appearance pattern of a character string or a part of speech which are preset as the first character recognition result is recognized, a second condition that an action performed on the target character string is input by the user's handwriting stroke, and a third condition that a first period has elapsed without the user's input since the acquisition of the handwriting stroke.

13. The method according to claim 8, wherein the one or more databases include a database generated based on a character string appearing in a document shared among a plurality of users.

14. The method according to claim 8, wherein the presenting the relevant character strings presents another relevant character string according to the first character recognition result.

15. A non-transitory computer readable medium including computer executable instructions, wherein the instructions, when executed by a processor, cause the processor to perform a method comprising:
determining a document type that is a type of a document containing a target character string, based on feature values including a first character recognition result and a first position information item, the target character string being a character string to be processed, the first character recognition result being a result of character recognition of the target character string, the first position information item indicating a position that the target character string appears in the document;
searching, if a search condition for searching for relevant character strings is satisfied, one or more databases for the relevant character strings to obtain the relevant character strings in order of decreasing score based on priorities, the relevant character strings being associated with the target character string, each of the priorities being set to each of the one or more databases according to the document type; and
presenting the relevant character strings in order of decreasing the score.

16. The medium according to claim 15, further comprising extracting, if the target character string is a handwriting stroke, a second character recognition result of the character recognition of the handwriting stroke and second position information on a character string represented by the handwriting stroke, as the feature values.

17. The medium according to claim 15, further comprising changing sizes of fonts of the target character string and a selected character string so that the target character string and the selected character string fit within a specified area in the document if the selected character string is inserted in the specified area, the selected character string being one of the relevant character strings selected in accordance with a user's instruction.

18. The medium according to claim 17, wherein the changing the sizes of fonts converts the selected character string into the user's handwriting font and inserts the converted selected character string into the document.

19. The medium according to claim 15, wherein the searching for the relevant character strings determines the search condition to be satisfied upon satisfaction of one of a first condition that an appearance pattern of a character string or a part of speech which are preset as the first character recognition result is recognized, a second condition that an action performed on the target character string is input by the user's handwriting stroke, and a third condition that a first period has elapsed without the user's input since the acquisition of the handwriting stroke.

20. The medium according to claim 15, wherein the presenting the relevant character strings presents another relevant character string according to the first character recognition result.
